(19) United States
(12) Patent Application Publication
(10) Pub. No.: US 2008/0203720 A1
(43) Pub. Date: Aug. 28, 2008

(54) STRETCHABLE BOOK COVERING WITH REINFORCING ELEMENTS

(75) Inventors: Cody Jon FOX, Charlotte, NC (US); Mark Tylor FOX, Charlotte, NC (US); Matthew Joseph FOX, Charlotte, NC (US); Daniel Lee BIZZELL, Davidson, NC (US); Tom Philpott, Charlotte, NC (US); Carole Ruffin, Charlotte, NC (US); Alexa Adams, Matthews, NC (US)

Correspondence Address: TILLMAN WRIGHT, PLLC, P.O. BOX 471581, CHARLOTTE, NC, 28247, US

(73) Assignee: BOUNCING BRAIN INNOVATIONS SEASON TWO SUBSIDIARY 8, LLC, Charlotte, NC (US)

(21) Appl. No.: 12/037,050

(22) Filed: Feb. 25, 2008

Related U.S. Application Data
(60) Provisional application No. 60/891,501, filed on Feb. 24, 2007.

(51) Int. Cl. B42D 3/02; B42D 3/00

(52) U.S. Cl. 281/35; 281/29

(57) ABSTRACT

A book covering includes a stretchable material, which completely extends over an outer face and side edges of each cover of a book, and reinforcing elements, which are disposed at localized areas of the stretchable material. The reinforcing elements include a resilient, pliable material.

### CROSS-REFERENCE TO RELATED APPLICATION

The present application is a U.S. nonprovisional patent application of, and claims priority under 35 U.S.C. §119(e) to, U.S. provisional patent application Ser. No. 60/891,501, filed Feb. 24, 2007, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

Many students are required by teachers to cover their textbooks with book coverings in order to protect the textbooks and keep them from becoming damaged during the school year. In fact, students often are required by a school or by a teacher to use a specific book covering selected by the school or by the teacher.

A book covering often selected by teachers and students is a book covering including a stretchable material, such as spandex, which enables a book covering of a single size to be used with books of varying sizes. Unfortunately, such book coverings have a tendency to wear in localized areas, which result in damage to the books. The localized areas of wear include areas in the corners of the book and at upper and lower spine areas of the book.

Examples of known book coverings that include stretchable material are disclosed in, for example: U.S. Pat. No. 2,311,153; U.S. Pat. No. 5,013,068; and U.S. Patent Publication No. 2005/0225073.

U.S. Pat. No. 2,311,153 discloses a book covering made from non-elastic material, such as paper or cloth, to which strips of stretchable elastic material are attached.

U.S. Pat. No. 5,013,068 discloses a stretchable book covering made from a composite material that includes an elastomeric, compressible foam with a polymeric fabric covering. A peripheral binding is attached to edges of the composite material at side, top, and bottom edges of the book. The peripheral binding may be composed of the same composite material as the rest of the book covering.

U.S. Patent Publication No. 2005/0225073 discloses a book covering that includes a stretchable material that is coated with elastomeric polyurethane resin to create a water-resistant barrier. The stretchable material comprises spandex or a similar material made of stretchable elastic threads.

It is believed that, even in view of the aforementioned book coverings, a need exists for an improved book covering that includes a stretchable material and that provides added protection in areas of localized wear. This, and other needs, are addressed by one or more aspects of the present invention.

### SUMMARY OF THE PRESENT INVENTION

The present invention generally relates to a book covering and, more particularly, to a book covering comprising a stretchable covering having reinforcing elements disposed at localized areas generally subject to wear such as, for example, locations coincident with corners and portions of a spine of a book being covered thereby.

The present invention includes many aspects and features. In an aspect of the invention, a book covering includes a stretchable material that completely extends over an outer face and side edges of each cover of a book and reinforcing elements disposed at localized areas of the stretchable material. The reinforcing elements comprise a resilient, pliable material.

In a feature of the first aspect, the reinforcing elements are integrally formed. In another feature, the reinforcing elements are permanently attached to, and are non-separable from, the stretchable material. In still another feature, the reinforcing elements are attached to the stretchable material using adhesive. In an additional feature, the localized areas correspond to corners of a book and upper and lower areas of a spine of the book.

In a further feature, the reinforcing elements include framing reinforcing elements. In accordance with this feature, the reinforcing elements further include a central spine member and upper and lower spine members. With regard to this feature, the central spine member includes a window slot. In further accordance with this feature, an exterior face and an interior face of the framing reinforcing elements have the same configuration such that the framing reinforcing elements look the same from the outside and the inside of a book.

In an additional feature, the stretchable material comprises spandex. With regard to this feature, the stretchable material further comprises a water-repellant material. In accordance with this feature, the book covering is waterproof

In another feature, the reinforcing elements comprise rubber. In yet another feature, the reinforcing elements comprise a thermoplastic material. With regard to this feature, the thermoplastic material is a thermoplastic elastomer. In additional feature, the reinforcing elements are injection molded onto, into, and/or through the covering. In a further feature, the reinforcing elements are disposed on an outside surface of the stretchable material. In yet a further feature, the reinforcing elements are disposed an inside surface of the stretchable material. In still yet another feature, the reinforcing elements form a decorative design. In an additional feature, a portion of the reinforcing elements include slots formed therein for insertion of the stretchable material.

In addition to the aforementioned aspects and features of the present invention, it should be noted that the present invention further encompasses the various possible combinations of such aspects and features.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is a perspective view of an exterior of a book covering in accordance with a preferred embodiment of the present invention in use on an open book;

FIG. 2 is a perspective view of an interior of the book covering in use on an open book;

FIG. 3 is an alternative perspective view of the interior of the book covering in use on an open book;

FIG. 4 is an isometric view of the reinforcing elements of the book covering;

FIG. 5 is a front view of reinforcing elements of the book covering;

FIG. 6 is a right side view of the reinforcing elements of the book covering;

FIG. 7 is a top view of the reinforcing elements of the book covering;

FIG. 8 is a bottom view of the reinforcing elements of the book covering;

FIG. 9 is a perspective view of an exterior of an alternative embodiment of the book covering in use on an open book;

FIG. 10 is a perspective view of an exterior of another alternative embodiment of the book covering in use on an open book;

FIG. 11 is a front perspective view of another alternative embodiment of the book covering in use on a closed book

FIG. 12 is a side view of the book covering of FIG. 11 in use on a closed book;

FIG. 13 is an inside plan view of the book covering of FIG. 11 in use on an open book;

FIG. 14 is an outside plan view of the book covering of FIG. 11 in use on an open book; and

FIG. 15 is a front perspective view of another alternative embodiment of the book covering in use on a closed book.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its applications, or uses.

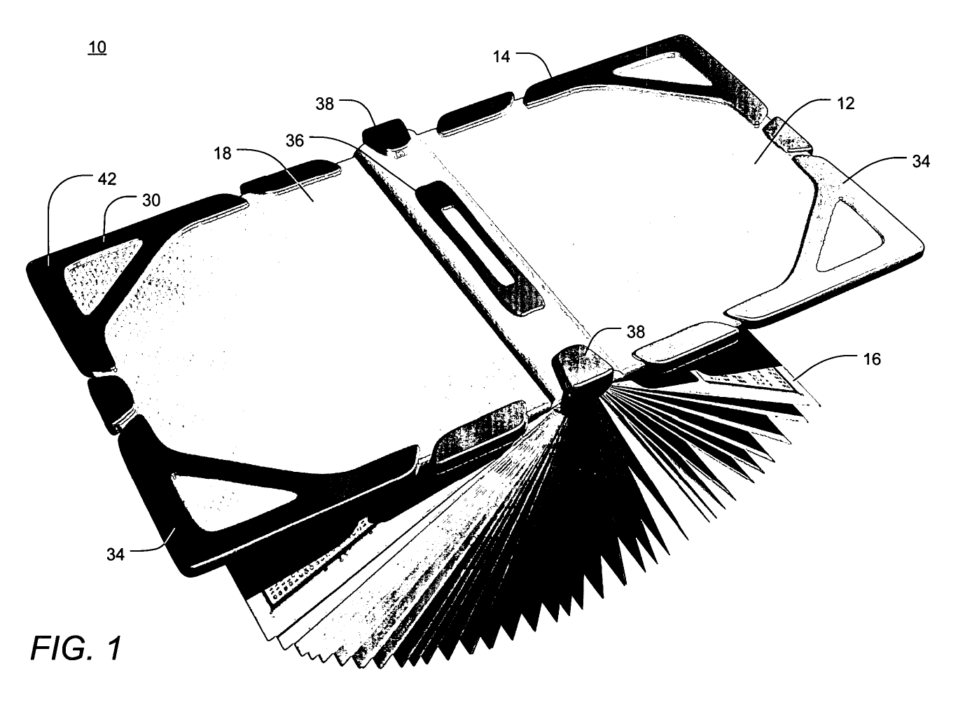

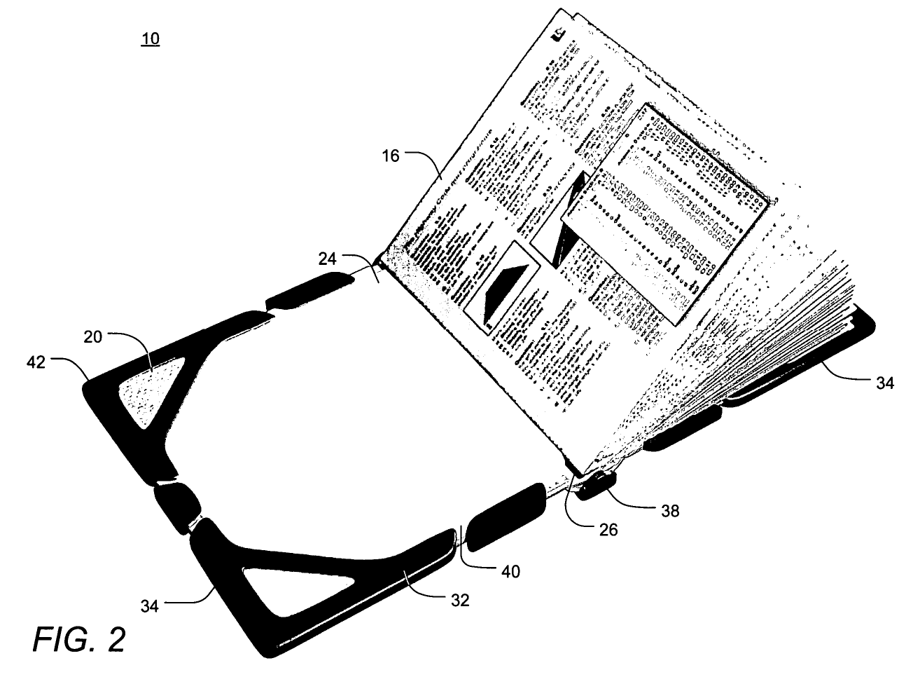

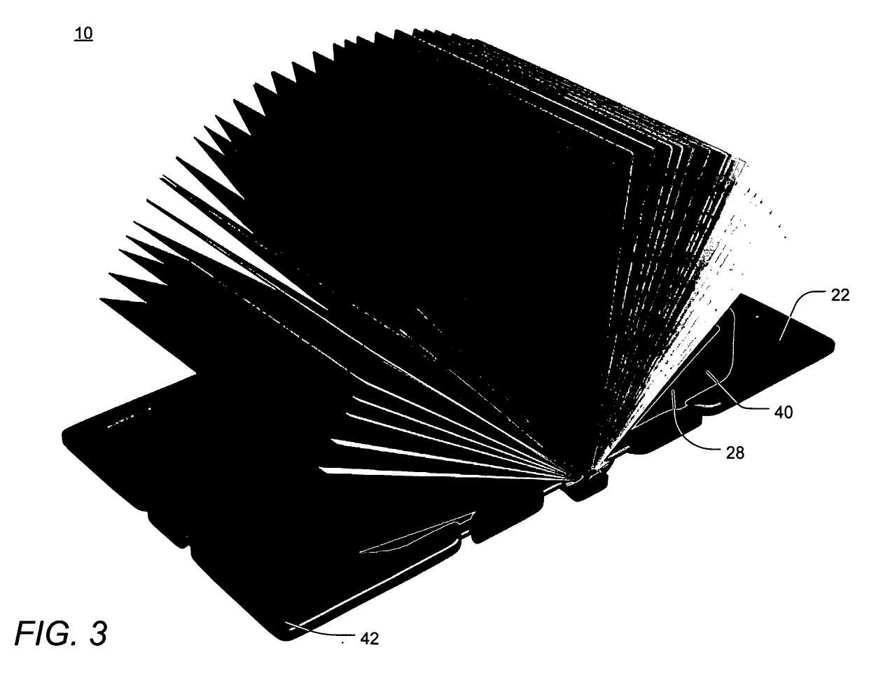

Turning now to the drawings, FIGS. 1-4 illustrate a book covering 10 in use on a book 16 in accordance with a preferred embodiment of the present invention. More particularly, FIG. 1 shows an exterior view of the book covering 10 in use on an open book 16 and FIGS. 2-3 show an interior view of the book covering 10 in use on an open book 16. The book covering 10 includes a stretchable material 12 that substantially covers the book 16 and reinforcing elements 14 that protect areas of the book 16 that typically experience localized wear.

The book covering 10 surrounds and protects a conventional book 16, i.e., a book having two covers 24,28 hingedly connected to one another by a generally centrally disposed spine 26. The book 16 has a front cover 24 and a back cover 28, each having an outer surface and an inner surface and side edges at the periphery of the covers 24,28, with the outer surface of the front cover 24 typically including an indication of the contents of the book such as a title, author's name, and descriptive artwork where appropriate. Each cover 24,28 of the book 16 includes an upper and a lower corner distal to the spine 26 of the book 16.

As mentioned above, the book covering 10 includes a stretchable material 12 that extends over outer and inner surfaces and side edges of the covers 24,28 of the book 16. In particular, the stretchable material 12 forms a single unit that includes an exterior panel 18 and a pair of partial interior panels 20,22. When placed on a book 16, the stretchable material 12 extends over the outer surfaces, side edges and portions of the inner surfaces of the front and back covers 24,28 of the book 26. The exterior panel 18 extends completely across the outer surfaces of the front and back covers 24,28 of the book 16, including the book spine 26. The exterior panel 18 folds over the side edges of the book 16 and is integrally connected with the interior partial panels 20,22. The interior partial panels 20,22 extend across a portion of the inner surfaces of the front and back covers 24,28 of the book beginning at the side edges of the book 16. More particularly, the interior partial panels 20,22 cover the corner portions of the inner surfaces of the book 16 and a extend slightly inwardly from the remaining side edges of the covers 24,28 of the book. As shown, the inner partial panels 20,22 of the stretchable material 12 is fixed to the reinforcing elements 14, which are explained in greater detail below, and does not extend beyond the reinforcing elements 14 over the inner surfaces of the covers 24,28 of the book 16. It is contemplated, however, that the stretchable material 12 may extend beyond the reinforcing elements 14 across the inner surface of the covers 24,28 of the book 16.

The stretchable material 12 preferably is constructed from a stretchable fiber material with elastic, pliable characteristics. It is preferred that the stretchable fiber material comprise spandex or another similar material made of stretchable elastic threads. It is further preferred that the stretchable fiber material include material components imparting water resistant properties to the book covering in order to repel liquids that come into contact with the book covering. Such water resistant material components are well known to the Ordinary Artisan.

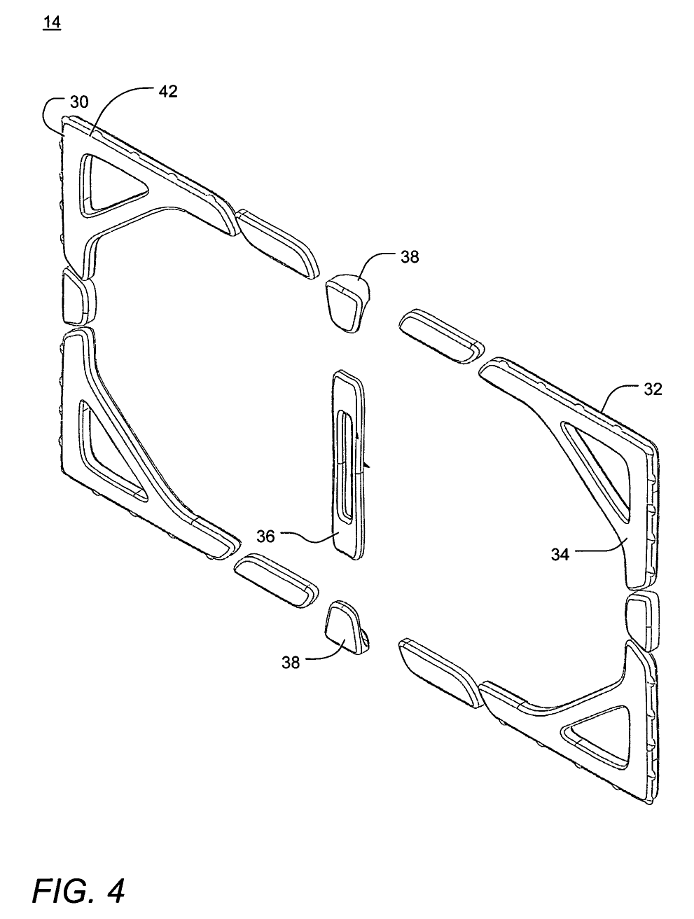

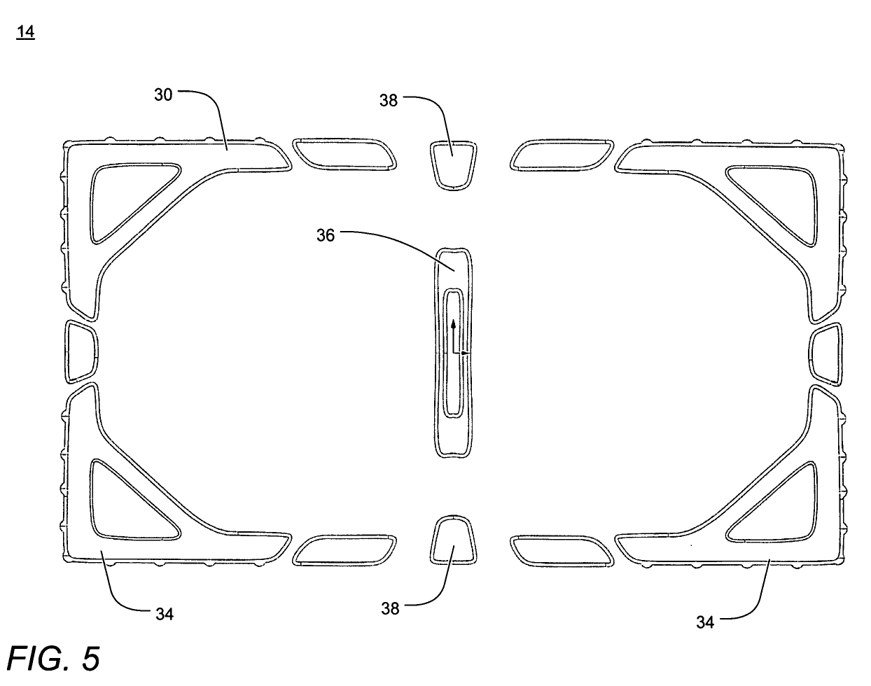

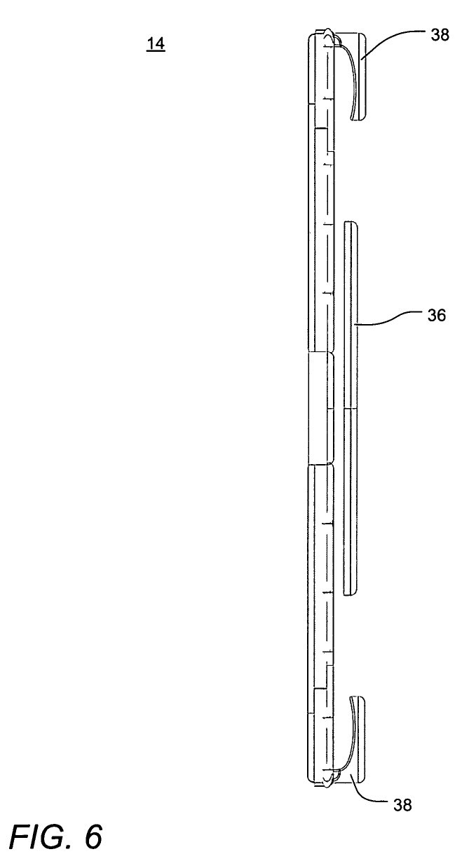

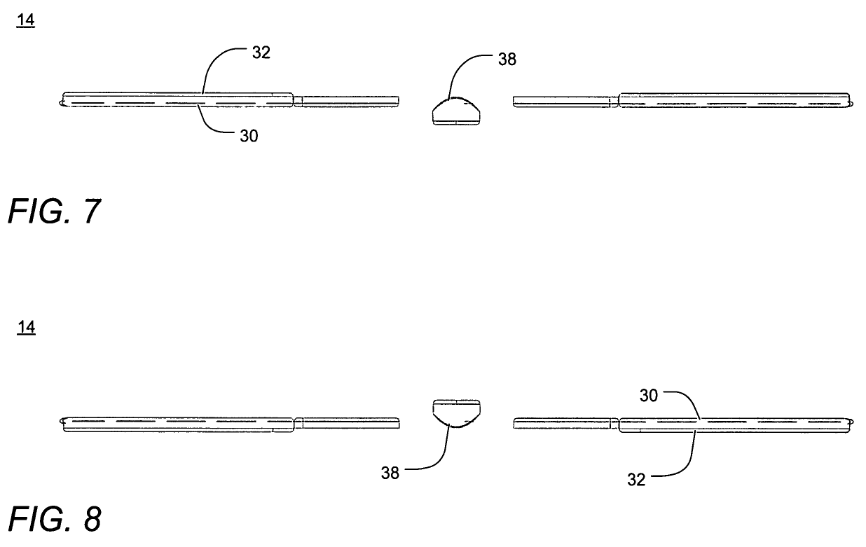

FIGS. 4-8 illustrate reinforcing elements 14 of the book covering 10 with the stretchable material 12 removed. More particularly, FIG. 4 is an isometric view of the reinforcing elements 14 of the book covering 10. FIG. 5 is a front view of reinforcing elements 14 of the book covering 10. FIG. 6 is a right side view of the reinforcing elements 14 of the book covering 10. FIG. 7 is a top view of the reinforcing elements 14 of the book covering 10, and FIG. 8 is a bottom view of the reinforcing elements 14 of the book covering 10.

FIGS. 4-8 illustrate both exterior and interior faces 30,32 of the reinforcing elements 14 in block form, i.e., without a slot for the stretchable material shown. The reinforcing elements 14 include framing reinforcing elements 34, a central spine member 36, and upper and lower spine members 28. The framing reinforcing elements 34 outline a substantial portion of a perimeter 40 of the covers 24,28 of the book 16, i.e., the framing reinforcing elements 34 essentially provide a frame for the front and back covers 24,28 of the book 16. Although it is not shown, a slot will be present in the framing reinforcing elements 34 between the exterior and interior faces 30,32 thereof for placement of the stretchable material 12. As can be seen the interior and exterior faces 30,32 of the framing reinforcing elements 34 are the same. Accordingly, the framing reinforcing elements 34 look the same from the exterior and the interior of the book 16.

The framing reinforcing elements 34 provide additional support to the perimeter area of the book 16. More particularly, the framing reinforcing elements 34 provide support to the outer surfaces of the book 16 near the perimeter 40, the inner surfaces of the book 16 near the perimeter 40, and the perimeter edges of the book 16. The framing reinforcing elements include corner reinforcing elements that provide support to the outer and inner surfaces of the book near the corners thereof and the edges there between. Book corners are a particular problem area for localized wear, therefore, the reinforcing elements are designed to cover, protect, and support corners of books 16.

The central spine member 36 is centrally disposed along the area of the stretchable material 12 that corresponds with a central spine area of the book 16. The central spine member 36 includes a window slot wherein a display insert indicating the book title, owner, subject, or the like may be inserted. The central spine member 36 is in contact with the exterior panel 18 of the stretchable material 12 only. The upper and lower spine members 38 are disposed at areas of the stretchable material 12 that are associated with ends of the spine of the book 16. The upper and lower spine members 38 cover and support the outer surface of the book 16 and the edges of the book 16 at the upper and lower ends of the spine 26. The upper and lower spine members 38 curve around the ends of the spine 26 without extending over the inner surface of the covers 24,28 of the book 16.

In addition to what is shown, it is also contemplated that the reinforcing elements 14 may be disposed simply at corners and at upper and lower spine areas of the stretchable material 12 that correspond with the corners and upper and lower spine areas of the book 16, respectively.

It is contemplated that in addition to providing increased support to portions of the book 16 near its outer edges, the reinforcing elements 14 may be extended across the exterior panel 18 of the stretchable material 12 in a decorative manner. For example, the reinforcing elements 14 may be extended into a web-like design depicting a spider web or may be extended into the shape of a particular mascot or logo. It will be understood by the Ordinary Artisan that the listed decorative designs are merely exemplary in nature and should not be limiting in any way.

The reinforcing elements 14 comprise a resilient, pliable material, such as, for example, plastic or hard rubber. Exemplary plastic materials include, but are not limited to, thermoplastic elastomers.

The reinforcing elements 14 may be integrally formed with the stretchable material 12 or may be adhered to the stretchable material 12. If the reinforcing elements 14 are integrally formed with the stretchable material 12, they may be injection molded to the stretchable material 12. Methods of injection molding plastic onto or into fabric are well known in other technology areas unrelated to the that of the present invention. For example, orthopedic devices with plastic injection molded onto fabric are disclosed in U.S. Pat. No. 6,024,712, the entirety of which are incorporated herein by reference.

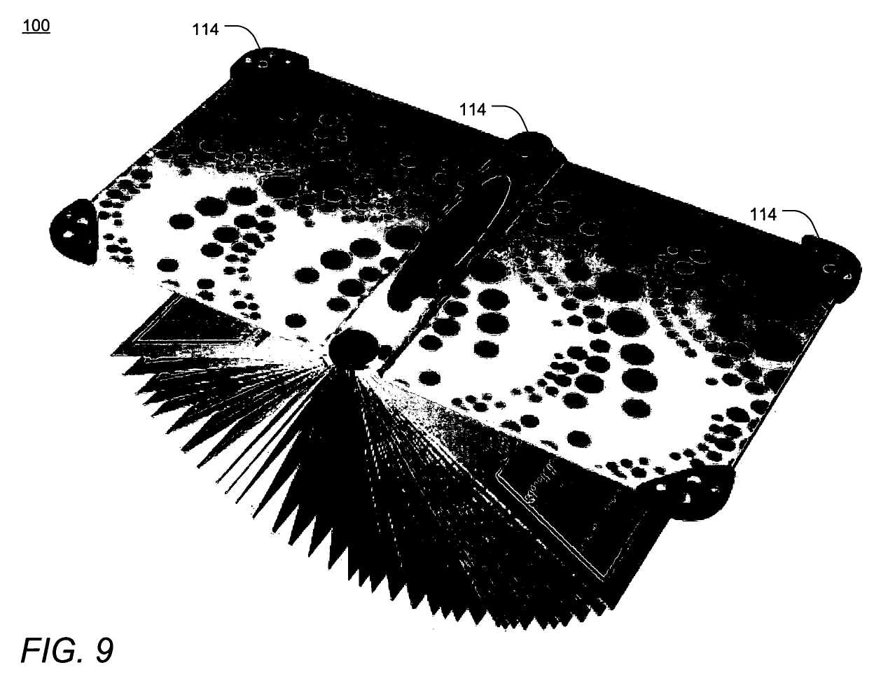

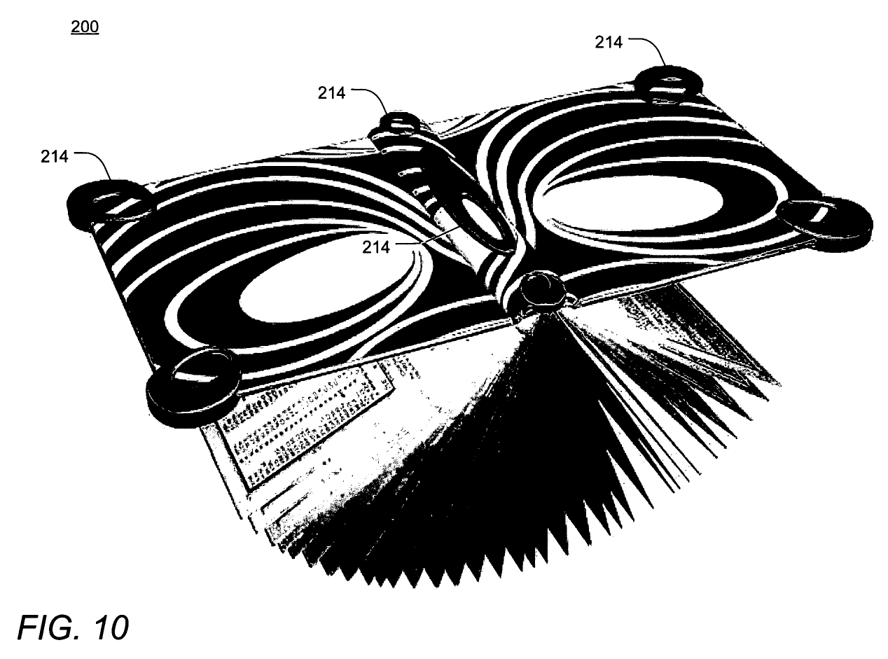

FIGS. 9 and 10 illustrate alternative embodiments of the book covering 100,200. In both embodiments, the reinforcing elements 114,214 are less extensive than in the embodiment of FIGS. 1-8, i.e., the reinforcing elements 114,214 are disposed at corners, upper and lower spine areas, and a central spine area. In the alternative embodiments, the reinforcing elements 114,214 continue to provide additional support in traditional areas of localized wear.

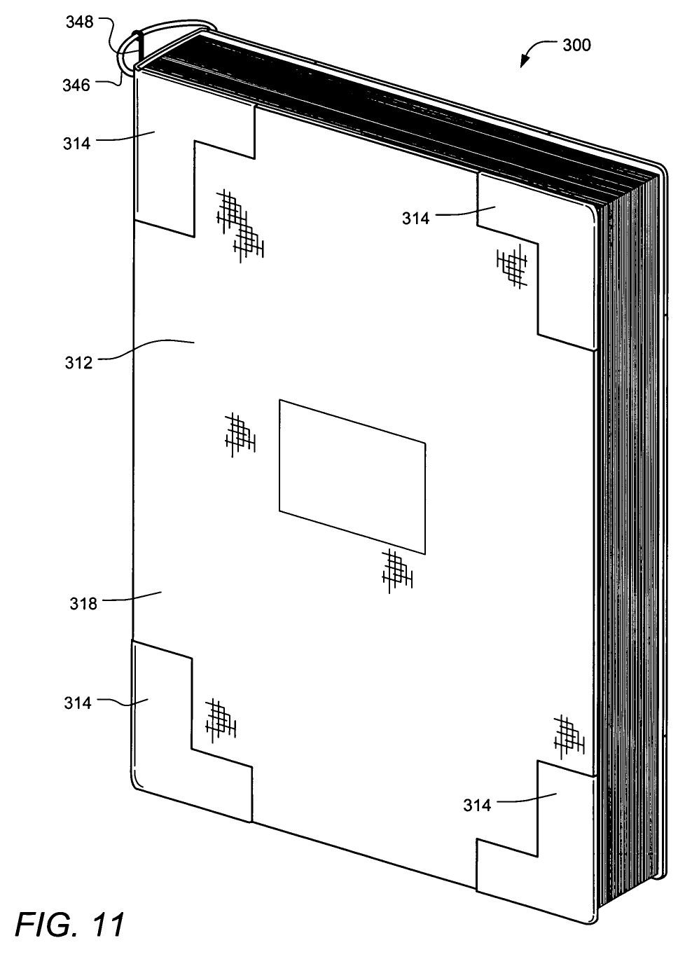

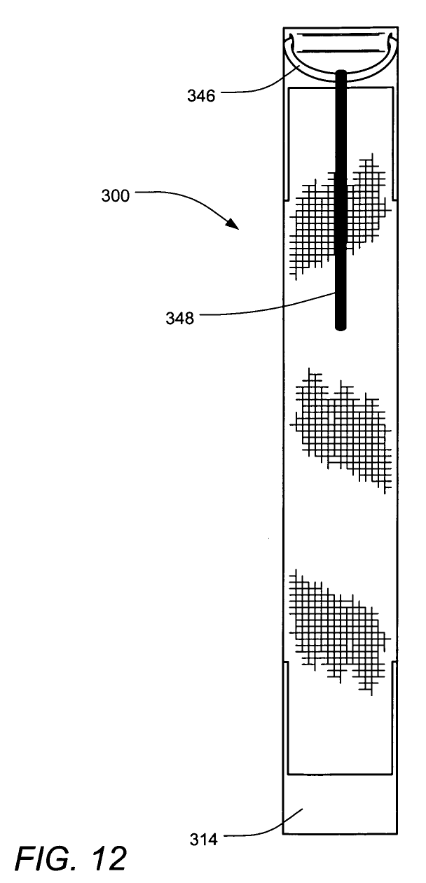

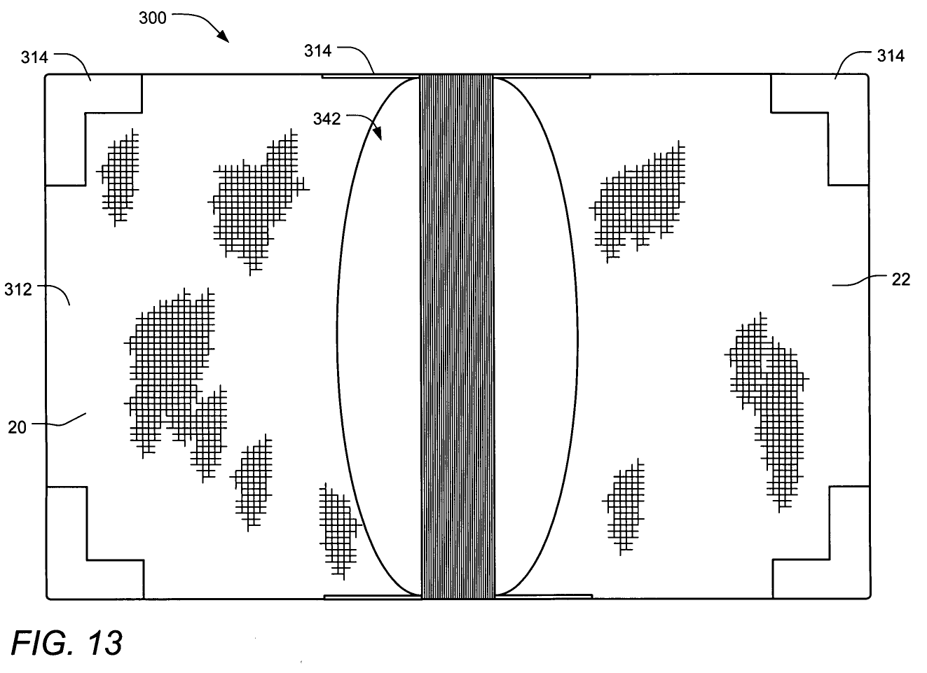

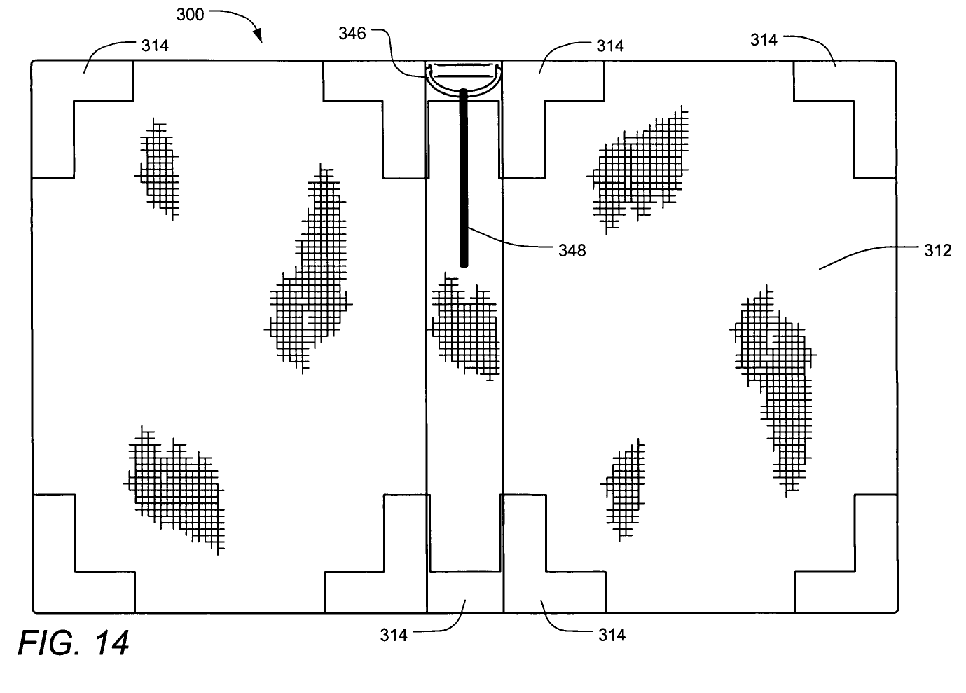

FIGS. 11-14 illustrate another alternative embodiment of a book covering 300 in use on a book 16. More specifically, FIG. 11 is a front perspective view of the book covering 300 in use on a closed book 16; FIG. 12 is a side view of the book covering 300 in use on a closed book 16; FIG. 13 is an inside plan view of the book covering 300 in use on an open book 16; and FIG. 14 is an outside plan view of the book covering 300 in use on an open book 16.

The book covering 300 surrounds and protects a conventional book 16. The stretchable material 312 completely extends over outer and inner surfaces and side edges of the covers 24,28 of the book 16.

In particular, the stretchable material 312 forms a single unit that includes an exterior panel 318 and a pair of interior panels 320,322. When placed on a book 16, the stretchable material 312 extends over the outer surfaces, side edges and substantial portions of the inner surfaces of the front and back covers 24,28 of the book 16. The exterior panel 318 extends completely across the outer surfaces of the front and back covers 24,28 of the book, including the book spine 26. The exterior panel 318 folds over the side edges of the book 16 and is integrally connected with the interior panels 320,322. The interior panels 320,322 extend across a substantial portion of the inner surfaces of the front and back covers 24,28 of the book 16 beginning at the side edges of the book 16; however, the stretchable material 312 includes a centrally disposed opening 342 between the interior panels 320,322 wherein the front and back covers 24,28 of the book 16 can be inserted into the stretchable material 312.

The reinforcing elements 314 at the corners of the book 16 provide additional support to the outer surfaces of the covers 24,28 of the book 16, the inner surfaces of the covers 24,28 of the book, and the side edges there between. Similarly, the reinforcing elements 314 at upper and lower areas of the covering 300 for protection of the spine 26 of the book 16 provide additional support to the outer surface of the spine 26 of the book 16, the inner surface of the spine 26 of the book 16, and the side edges there between.

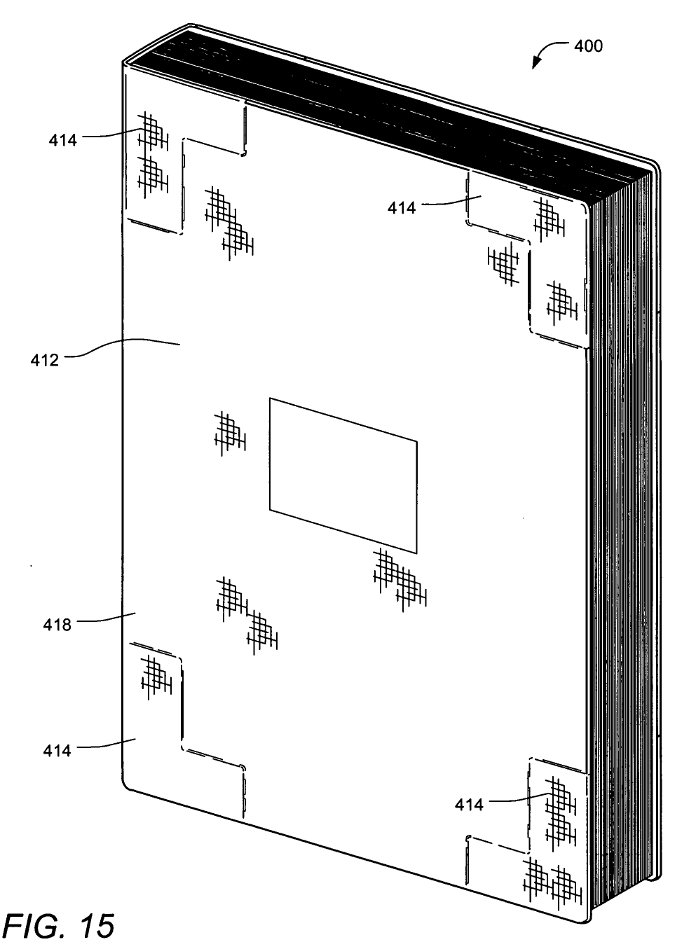

In the embodiments shown herein, the reinforcing elements 14,114,214,314 are disposed exterior to the book covering 10,100,200,300 in relation to the book 16. It is contemplated that the reinforcing elements 14,114,214,314 may be disposed interior to the book covering 10,100,200,300 in relation to the book 16. Such an embodiment is represented by the book covering 400 in FIG. 15, wherein reinforcing elements 414 are disposed on the interior of the panel 418 of the layer of stretchable material 412 and are in contact with the front cover 24 of the book 16. Similarly, reinforcing elements 414 are disposed on the interior of the panel 418 of the layer of stretchable material 412 and are in contact with the rear cover 28 and the spine of the book (not shown). As such, the reinforcing elements 414 are not visible to an observer from the exterior of the book covering 400.

It is also contemplated that the book covering may include two layers of stretchable material, with the reinforcing elements disposed between the two layers of stretchable material. In this embodiment, the reinforcing elements are not in contact with the front and back covers of the book when the book covering is in use, nor are the reinforcing elements visible to an observer when the book covering is in use. Rather, the reinforcing elements are essentially hidden between the two layers of the stretchable material, with a first layer of the covering being in contact with the covers of the book and a second layer of the covering being seen by observers and exposed to environmental elements.

As shown in the drawings, the book covering 300 may include a grasping element 344. As shown, the grasping element 344 comprises a ring 346 that is secured to a reinforcing element 314 at the spine 26 of the book 16 for hinging movement relative thereto. Alternatively, the grasping element 344 may be formed integrally with, and comprised as the same material as, the reinforcing element 314 at the spine 26 of the book 16. It is contemplated that the grasping element 314 may be formed integrally with the upper reinforcing element 314 and/or lower reinforcing element (not shown).

Additionally, the book covering 300 may include a book mark 348 integrally formed with one or more reinforcing elements 314 at the spine 26 of the book 16. It is preferred that the book mark 348 be formed of the same material as the reinforcing element 314. As shown in the drawings, the book mark 348 comprises an integrally formed appendage to the grasping element 344. However, it will be understood by the Ordinary Artisan that the book mark 348 may be integrally formed with a reinforcing element 314 at the spine 26 of the book 16 whether or not a grasping element 344 is present.

In use, a book 16 is inserted into the book covering 10 by sliding the front cover 24 of the book 16 between the exterior panel 18 and interior panel 20 and sliding the back cover 28 of the book 16 between the exterior panel 18 and interior panel 22. Because of the stretchable nature of the stretchable material 12, the book covering 10 is essentially “one size fits all” for most books. The localized location of the reinforcing elements 14 on the covering 10 ensures that the reinforcing elements 14 do not restrict or otherwise inhibit the stretchability of the stretchable material 12. Indeed, for any book covering 10 that includes reinforcing elements 14 that extend onto the interior and exterior panels 20,22,18 of the stretchable covering to form a decorative design, care should be taken to ensure that the stretchability and expandability of the stretchable material 12 is not substantially compromised. This preferably is accomplished by isolating the reinforcing elements 14, i.e., by separating the reinforcing elements 14 so that no two reinforcing elements 14 are connected or otherwise joined or connected to one another. In other words, the reinforcing elements 14 are discontinuous.

When the book 16 is inserted into the book covering 10, the reinforcing elements 14 of the book covering 10 are aligned with at least the corners and spine of the book 16 and provide extra support for these regions that typically experience more stress and strain during normal usage.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A book covering, comprising:
(a) a stretchable material that completely extends over an outer face and side edges of each cover of a book; and
(b) reinforcing elements disposed at localized areas of the stretchable material;
(c) wherein said reinforcing elements comprise a resilient, pliable material.

2. The book covering of claim 1, wherein the reinforcing elements are integrally formed.

3. The book covering of claim 1, wherein the reinforcing elements are permanently attached to, and are non-separable from, the stretchable material.

4. The book covering of claim 1, wherein the reinforcing elements are attached to the stretchable material using adhesive.

5. The book covering of claim 1, wherein the localized areas correspond to corners of a book and upper and lower areas of a spine of the book.

6. The book covering of claim 1, wherein the reinforcing elements include framing reinforcing elements.

7. The book covering of claim 6, wherein the reinforcing elements further include a central spine member and upper and lower spine members.

8. The book covering of claim 7, wherein the central spine member includes a window slot.

9. The book covering of claim 6, wherein an exterior face and an interior face of the framing reinforcing elements have the same configuration such that the framing reinforcing elements look the same from the outside and the inside of a book.

10. The book covering of claim 1, wherein the stretchable material comprises spandex.

11. The book covering of claim 10, wherein the stretchable material further comprises a water-repellant material.

12. The book covering of claim 10, wherein the book covering is waterproof.

13. The book covering of claim 1, wherein the reinforcing elements comprise rubber.

14. The book covering of claim 1, wherein the reinforcing elements comprise a thermoplastic material.

15. The book covering of claim 14, wherein the thermoplastic material is a thermoplastic elastomer.

16. The book covering of claim 1, wherein the reinforcing elements are injection molded onto, into, and/or through the covering.

17. The book covering of claim 1, wherein the reinforcing elements are disposed on an outside surface of the stretchable material.

18. The book covering of claim 1, wherein the reinforcing elements are disposed an inside surface of the stretchable material.

19. The book covering of claim 1, wherein the reinforcing elements form a decorative design.

20. The book covering of claim 1, wherein a portion of the reinforcing elements include slots formed therein for insertion of the stretchable material.
